(19) United States
(12) Patent Application Publication
(10) Pub. No.: US 2003/0142920 A1
(43) Pub. Date: Jul. 31, 2003

(54) Method and apparatus for optical fiber array assembly

(76) Inventors: Joseph L. Dallas, Maple Glen, PA (US); Angelique X. Irvin, Radnor, PA (US); Robert W. Irvin, Radnor, PA (US); Ralph S. Jameson, Orefield, PA (US); William A. Mamakos, Laurel, MD (US)

Correspondence Address: CANTOR COLBURN, LLP, 55 GRIFFIN ROAD SOUTH, BLOOMFIELD, CT, 06002

(21) Appl. No.: 10/058,846

(22) Filed: Jan. 28, 2002

(51) Int. Cl. G02B 6/36

(52) U.S. Cl. 385/80; 385/83; 385/137

(57) ABSTRACT

A system and method for fabricating an array of multiple optical fibers is disclosed. The method comprises providing a substrate having a plurality of guides formed therein each penetrating through the substrate, the substrate having one or more via holes in fluid communication with the plurality of guides. The plurality of optical fibers is disposed with respective guides, each of the optical fibers being placed with a corresponding one of the guides. An adhesive is injected into the one or more via holes, the adhesive fixing the optical fibers in the respective guides of the substrate.

### BACKGROUND

The present invention relates to an optical fiber array, and more particularly, to a method and apparatus for fiber array assembly.

Generally, a multi-fiber array has two substrates, such as upper and lower substrates, so that multiple optical fibers are arranged between the two substrates. The optical fibers are bonded to one or both of the substrates by use of adhesive material. During arrangement and bonding of the optical fibers, positions of the optical fibers should be controlled with accuracy. Precise alignment of optical fibers (especially, optical fiber cores) is an important factor in determining efficiency with which the optical fiber array can be mated to a corresponding array of optical devices. Any deviation in the alignment of optical fibers affects light transmission of the optical fibers.

Referring to FIG. 1, a cross-sectional, perspective view is provided for illustrating a typical array of multiple optical fibers. A multi-fiber array 100 includes two substrates, i.e., upper and lower substrates 110, 112, and multiple optical fibers 114 are arranged between the two substrates 110, 112. As shown in FIG. 1, the upper and lower substrates 110, 112 have V-grooves 116, 118 to hold the optical fibers 114 and larger grooves 120, 122 to hold guides (e.g., alignment pins) 124. Alternatively, upper substrate 110 does not have corresponding V-grooves 116 and is substantially planar. The larger grooves 120, 122 are disposed at both sides of the V-grooves 116, 118 and are used to connect the array 1100 to another array or optical device. The optical fibers 114 and the guides 124 are aligned on the respective grooves 116-122 and fixed therein by adhesive material 126.

A typical process of fabricating the conventional multi-fiber array 100 is as follows. The upper and lower substrates 110, 112 are first subjected to a mechanical and/or chemical process to form the grooves 116-122 on the respective surfaces of the substrates 110, 112. The optical fibers 114 and guides 124 are mounted on the respective V-grooves 118 and larger grooves 122 of the lower substrate 112.

After the fibers 114 and guides 124 are placed in alignment with the respective grooves 118, 122, the adhesive 126 is applied over the lower substrate 112 so that the fibers 114 and guides 124 are coated with the adhesive 126. Then, the upper substrate 110, which may also have corresponding V-grooves 116 and larger grooves 120 on its face, is fitted on top of the lower substrate 112 with the fibers 114 and guides 124 disposed thereon. At this time, the V-grooves (if present) and larger grooves 116, 120 of the upper substrate 110 are disposed to be aligned with the respective grooves 118, 122 of the lower substrate 112 in their longitudinal direction.

The upper and lower substrates 110, 112 are bonded to each other with the adhesive 126 by pressing the upper substrate 110 toward the lower substrate 112. Upon consummation of the above processes, the multi-fiber array 100 is formed in which the optical fibers 114 are fixed with the adhesive 126 between the V-grooves 116, 118 of the upper and lower substrates 110, 112.

Examples of multi-fiber arrays can be found in U.S. Pat. No. 6,215,945 to Fukuyama et al., issued on Apr. 10, 2001, “Optical Fiber Array”; and U.S. Pat. No. 5,790,731 to G. Deveau, issued on Aug. 4, 1998, “Optical Fiber Array/Optical Integrated Circuit Interconnection Assembly and Enclosures for Protecting the Interconnection Assembly”.

However, the conventional method of fabricating a multi-fiber array has drawbacks in that alignment and/or position of each optical fiber core cannot be controlled precisely. Such deviation in the alignment and positions of the optical fiber cores is mainly caused by one or more of the following factors.

First, the optical fiber core of the optical fiber may be misaligned with respect to the true mechanical center of the optical fiber. This results from the processes used to manufacture the optical fiber. Current manufacturing technology allows fabrication of 125 micron diameter optical fibers that have optical fiber cores approximately 10 micron diameter with an accuracy such that the optical fiber core is aligned with the true mechanical center of the optical fiber to within +/−0.5 micron. When such an optical fiber is positioned in a fiber array and the optical fiber is aligned to place the true mechanical center in a desired position, the optical fiber core position may depart the from desired location.

Second, the optical fiber itself may depart in its cross section from the ideal circular shape, so that the optical fiber cross section is slightly elliptical. Current manufacturing technology allows the manufacture of 125 micron diameter optical fibers that have optical fiber cores approximately 10 micron diameter with an accuracy such that the smaller and larger elliptical diameters of the optical fiber cross section are equal to within 1 micron. When such an optical fiber is placed in an optical fiber array and the fiber is positioned in contact with a reference surface, such as the aforementioned substrate or V-groove array, the position of the true mechanical center of the optical fiber may depart from the desired location, resulting in an error in the position of the optical fiber core.

Third, in the V-groove substrate upon which the optical fiber array is assembled, the position and depth of each V-groove is subject to some variability during the V-groove substrate manufacturing process. Current manufacturing technology permits the fabrication of V-groove substrates wherein the combined error of the position of the V-groove and the depth of the V-groove is less than 0.5 micron.

Fourth, during the assembly of the optical fiber array, when the optical fibers are aligned in their desired positions, the application of an adhesive to the array may disturb the position of the optical fibers. For example, the surface tension of the adhesive may displace the optical fiber as the adhesive wets the surface of the optical fiber.

Fifth, when the adhesive is in position on the fiber array, the application of the aforementioned upper substrate causes the adhesive further to flow across the array of fibers. This adhesive flow may further displace the position of the optical fibers, because the fibers are not mechanically held in position in the region of the adhesive flow.

In other words, the optical fibers may be deviated from their target positions when being arranged or pressed by the upper substrate toward the lower substrate. As a result, cores of the optical fibers may also be deviated from their target positions. Therefore, a need exists for a method of fabricating a multi-fiber array in which position of each optical fiber core is controlled with high accuracy so that the optical fiber cores are precisely aligned with optical devices or waveguides disposed in connection with the array.

### BRIEF SUMMARY

In a first aspect of the present invention, there is provided a method for fabricating the fiber array that comprises providing a substrate having a plurality of guides formed therein each penetrating through the substrate, the substrate having one or more via holes in fluid communication with the plurality of guides; disposing the plurality of optical fibers within respective guides, each of the optical fibers being placed within a corresponding one of the guides; and injecting an adhesive into the one or more via holes, the adhesive fixing the optical fibers in the respective guides of the substrate.

According to another aspect of the present invention, a fiber array comprises a substrate having a plurality of guides formed therein each penetrating through the substrate, the substrate having one or more via holes in fluid communication with the plurality of guides; the plurality of optical fibers each disposed with respective guides, each of the optical fibers being placed with a corresponding one of the guides in the substrate; and adhesive material surrounding each of the optical fibers in a corresponding guide to fix the position of each optical fiber, the adhesive being applied through the one or more via holes.

### BRIEF DESCRIPTION OF THE DRAWINGS

This disclosure will present in detail the following description of preferred embodiments with reference to the exemplary drawings wherein like elements are numbered alike in the several FIGURES:

FIG. 1 is a cross-sectional, perspective view illustrating a typical array of multiple optical fibers;

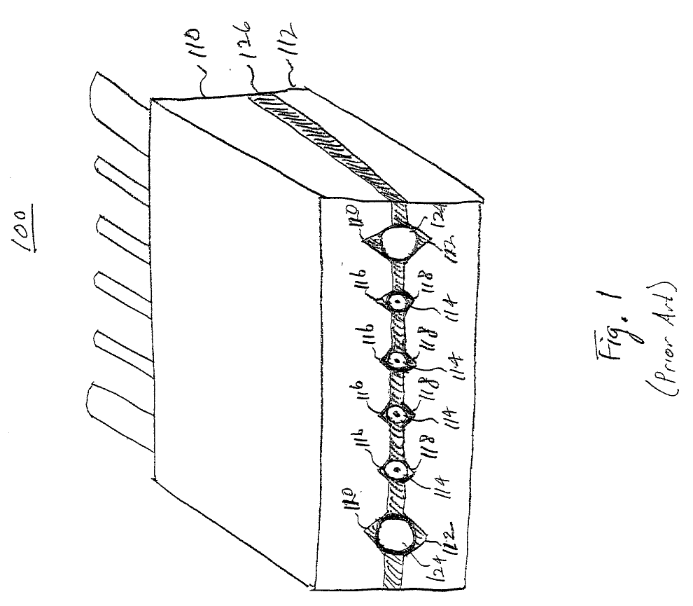

FIG. 2 a perspective view illustrating a multi-fiber array including via holes;

FIG. 3 a perspective view illustrating a multi-fiber array including via holes and a channel;

FIG. 4 a perspective view illustrating a multi-fiber array including a single via hole and a channel;

FIG. 5 a perspective view illustrating a multi-fiber array including via holes and a channel according to another alternative embodiment;

FIG. 6 is a flow chart describing a method of fabricating a multi-fiber array; and

FIG. 7 is a perspective view illustrating a multi-fiber array including a via hole according to another alternative embodiment.

### DETAILED DESCRIPTION OF THE PREFERRED EMBODIMENTS

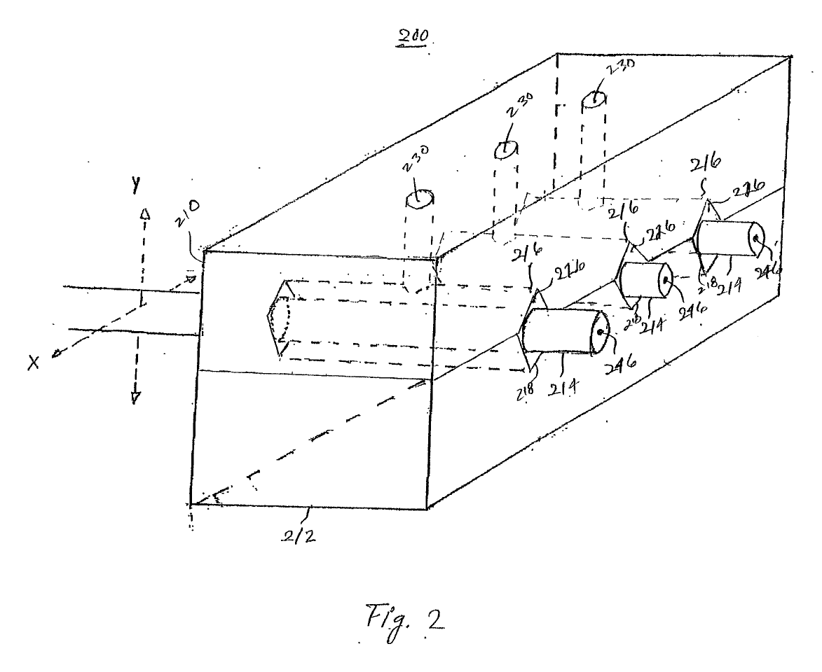

Some embodiments of the invention will now be described in detail in the following Examples. FIG. 2 is a perspective view illustrating a multi-fiber array 200. In the multi-fiber array 200, a fiber array member 212 is provided to arrange and fix multiple optical fibers 214 therein. The fiber array member 212 has guides 218 each extending throughout the fiber array member 212 in a direction corresponding to a longitudinal direction of the optical fibers 214. The guides 218 are preferably configured as V-shaped grooves, as shown, but are optionally configured as a U-shaped groove or squared groove, and the like. A second array member 210 is provided having via holes 230 configured therein. The via holes 230 are in fluid communication with guides 216 configured in second array member 210 and each guide 216 is aligned with a corresponding guide 218 for capturing a respective optical fiber 214. As in the guides 218 of first array member 212, guides 216 are preferably configured as V-shaped grooves, as shown, but are optionally configured as a U-shaped groove or squared groove, and the like. It will also be appreciated that guides 216, 218 may be complimentary configured, or may have different configurations for capturing and aligning each optical fiber 214. For example, guide 216 may be V-shaped, while guide 216 may be U-shaped or not shaped at all. Second array member 210 is aligned to cover first array member 212 for pressing and capturing each optical fiber 214 in a respective guide 216, 218. An adhesive material 226, preferably UV-cure adhesive, which is solidified by being exposed to UV (ultraviolet) light, or a heat cured epoxy, is injected in each via hole 230 for bonding and sealing the fiber array 200. When adhesive 226 is injected in via holes 230, each of the optical fibers 214 is coated, preferably airtightly, with the adhesive 226 adhering the first and second array members through fluid communication of adhesive 226 between guides 216 and 218. It will be noted that FIG. 2 depicts a via hole 230 aligned with each guide 216, 218 for injecting adhesive 226 in a cavity created when first and second array members 210, 212 are joined, however, it is preferable that via holes 230 are in fluid communication with a channel configured in one or both array members 210, 212 for sealing and adhering first and second array members 210, 212 together.

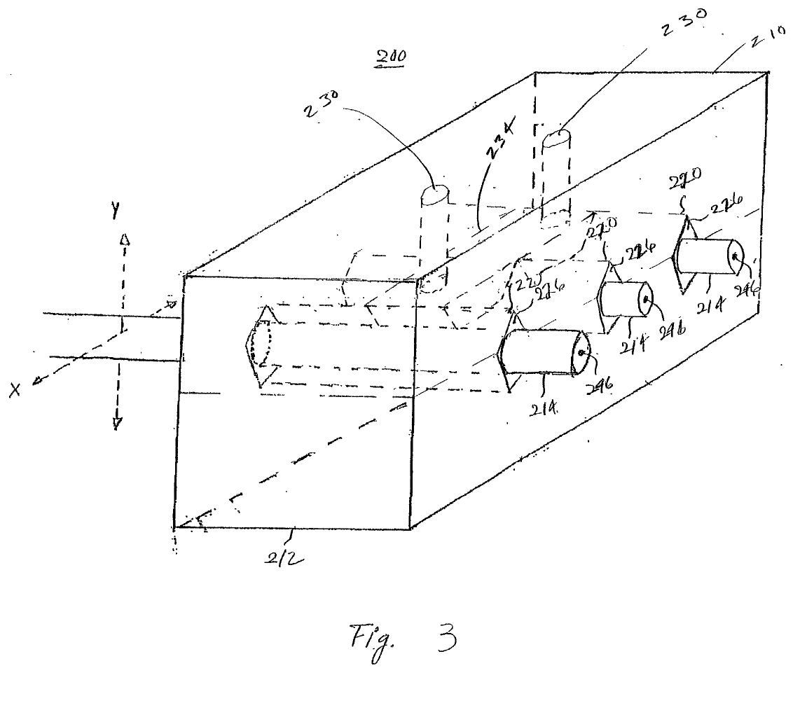

Referring to FIG. 3, an alternative exemplary embodiment is shown illustrating a channel 234 (shown with phantom lines) configured in second array member 210 providing fluid communication between via holes 230. Fiber array 200 is also shown using array member 212 having guides 220 configures therein for capturing and alignment of optical fibers 214. Via holes 230 shown in FIG. 3 are not aligned with each guide 220 and are disposed approximately intermediate contiguous guides 220. Via holes 230 in fluid communication with channel 234 configured in array member 212 creates a cavity that defines the fluid communication between guides 220, channel 234 and via holes 230.

In the case that UV-cure adhesive is injected in via holes 230 and used as the adhesive 226 for retaining aligned optical fibers 214, the optical fibers 214 are movable in the respective guides 220 unless the UV-cure adhesive is exposed to UV light. Before the UV-cure adhesive 226 is solidified by being exposed to UV light, the optical fibers 214 coated with the UV-cure adhesive 226 may be readily adjusted to desired positions so that cores 246 of the optical fibers 214 are aligned with their target positions. The optical fibers 214 are then fixed on the desired positions by solidifying the UV-cure adhesive 226. Thus, active adjustment or repositioning of each optical fiber 214 may be performed to accomplish accurate alignment of each optical fiber core. In the case that the adhesive 226 is a heat cured epoxy, active adjustment of each optical fiber 214 may be performed prior to application of heat to cure the epoxy.

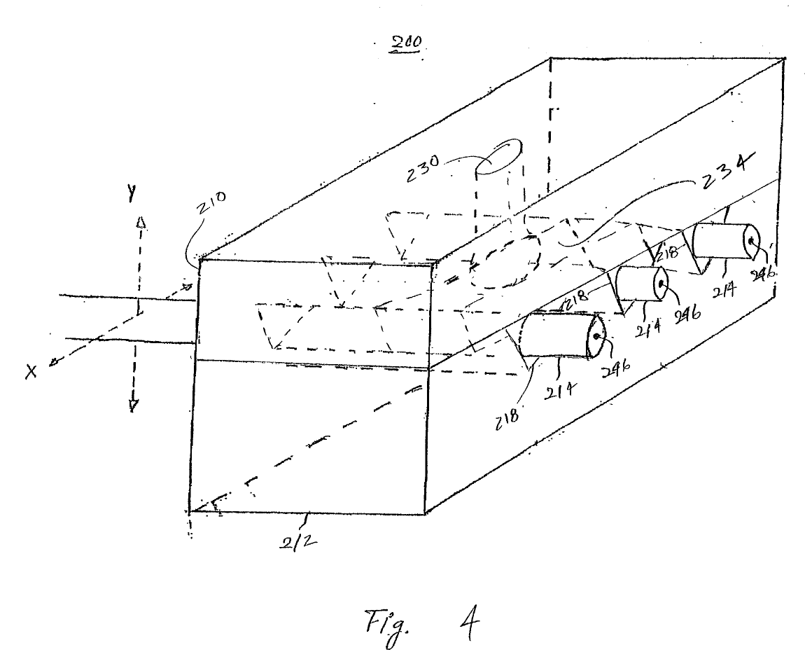

Referring to FIG. 4, another alternative embodiment of the fiber array 200 shown in FIG. 2 is illustrated. The fiber array 200 in FIG. 4 includes fiber array member 212 of FIG. 2 having a second fiber array member 210 having no guides 216 configured therein. Second array member 210 includes one via hole 230 that extends to channel 234, which in turn is in fluid communication with each guide 218 for bonding second fiber array member 210 with fiber array member 212 when adhesive 226 is injected in via hole 230 and allowed to cure. In this embodiment, it will be noted that guides 218 may be configured to provide passive or active alignment of optical fibers 214.

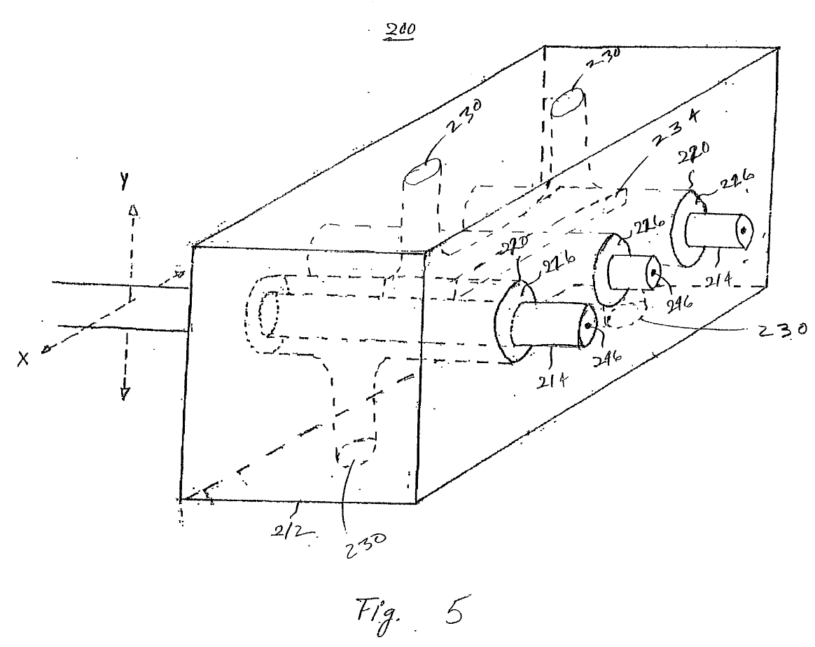

Referring to FIG. 5, another alternative embodiment of fiber array 200 shown in FIG. 3 is illustrated. Fiber array 200 in FIG. 5 includes unitary fiber array member 212 having guides 220 configured as through-holes extending from one end to the other in fiber array member 212. Via holes 230 are substantially perpendicular to the through-hole guides 220 and extend to channel 234 that is configured to provide fluid communication between via holes 230 and guides 220. Via holes 230 are disposed on opposite sides of 212 and are offset from each guide 220. In other words, via holes 230 are not aligned with guides 220.

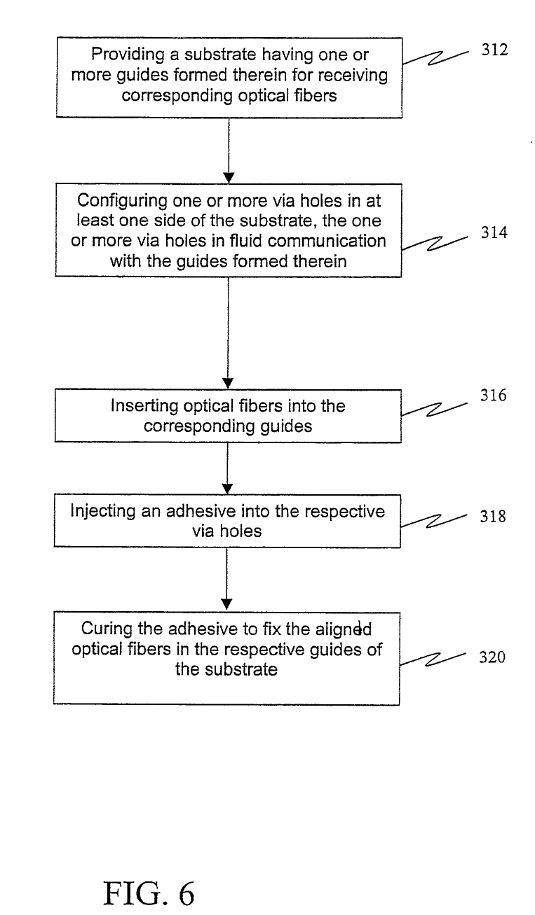

Referring to FIG. 6, a flow chart is provided for describing a method of fabricating a multi-fiber array according to an exemplary embodiment of the present disclosure. The method of fabricating a multi-fiber array will be described with reference to FIGS. 3, 5 and 6.

A unitary substrate is provided to be used as the fiber array member 212 (block 312). The unitary substrate 212 has the guides 220 formed therein, substantially parallel with each other. The guides 220 may be formed through a mechanical or chemical process, or the unitary substrate 212 may be molded to have the guides 220. The guides are configured to either engage an outside diameter of the optical fibers 214 or have a cross sectional diameter larger than that of the optical fibers 214 to be inserted into the guides 220. The guides 220 are also formed to be spaced from each other by a predetermined distance which depends on the size of a multi-fiber array 200 and the number of the optical fibers 214 to be arranged in the array. In addition, the guides 220 are preferably formed having the same distance from the bottom of the unitary substrate 212.

Substrate 212 is also configured having one or more via holes 230 on at least one side of the substrate 220 (block 314). The one or more via holes are configured to provide fluid communication with the guides 220 formed in substrate 212. Via holes 230 may be formed through a mechanical or chemical process, or the unitary substrate 212 may be molded to have the via holes 230. Via holes 230 are substantially perpendicular to guides 220. Via holes 230 are optionally in fluid communication with a channel 234, which in turn is in fluid communication with guides 220 at block 314. Furthermore, it will be appreciated that if upper and lower substrates 210, 212 are used instead of unitary substrate 212, channel 234 may also provide fluid communication between surfaces of upper and lower substrates facing each other to be joined.

Next, the optical fibers 214 are inserted into the respective guides 220 formed in the unitary substrate 212 (block 316). An adhesive 226, preferably an UV-cure adhesive 226, is then injected into the respective guides 220 (block 318). As a result, each of the optical fibers 214 is coated with the UV-cure adhesive 226 in a corresponding guide 220. At this time, the UV-cure adhesive 226 should be protected from UV light to prevent the UV-cure adhesive 226 from being solidified. Since the UV-cure adhesive 226 has liquid property unless being exposed to UV light, the optical fibers 214 coated with the UV-cure adhesive 226 are movable in the respective guides 220. Alternatively, adhesive 226 may be a heat cured epoxy. Since the epoxy has liquid property prior to being cured, the optical fibers 214 are moveable in the respective guides 220.

Under control of an adjusting mechanism, each of the optical fibers 214 is adjusted or repositioned, for example, in horizontal and vertical directions (x, y) in accordance with reference measurements so that the cores 246 of the respective optical fibers 214 are accurately aligned according to a predetermined optical alignment. Such active alignment is performed with respect to each of the optical fibers 214 sequentially or simultaneously. In other words, the optical fibers 214 may be separately adjusted or repositioned by the respective manipulators in accordance with the reference measurements so that each optical fiber core is separately aligned with its target position. In another embodiment, the optical fibers 214 may be simultaneously adjusted so that the optical fiber cores 246 may be aligned at the same time.

If guides 220 are configured to provide passive alignment when optical fibers 214 are inserted (block 316), optical fibers do not require the active alignment described above. This is particularly the case when using upper and lower substrates 210, 212 instead of unitary substrate 212, wherein at least lower substrate 212 is configured having guides 118 to provide passive alignment of optical fibers 214 with respect to each guide 118.

When the optical fiber cores 246 are accurately aligned with their target positions, the UV-cure adhesive 226 is exposed to UV light or allowed to cure (block 320). As a result, the UV-cure adhesive 226 is solidified and the optical fibers 214 are fixed in the respective guides 220. The optical fibers 214 coated with the UV-cure adhesive 226 may be fixed separately or simultaneously. In other words, all the optical fibers 214 may be fixed simultaneously by exposing the entire UV-cure adhesive 226 to UV light at the same time. In this case, the optical fibers 214 are simultaneously adjusted as described above. Alternatively, with adhesive 226 a heat cured epoxy, the fibers may be fixed in place by applying heat to cure the epoxy.

In another embodiment, the optical fibers 214 may be separately fixed in the respective guides 220. In this case, the optical fibers 214 are separately adjusted as described above with active alignment. The UV light is only applied to the UV-cure adhesive coating the optical fiber(s) which is completely aligned in accordance with the predetermined optical alignment, while the UV-cure adhesive coating the optical fibers which are not completely aligned is protected from the UV light. Thus, the optical fibers 214 may be separately or sequentially adjusted and fixed in the respective guides 220. Therefore, the cores 246 of the optical fibers 214 are accurately and aligned with their target positions in accordance with the predetermined optical alignment.

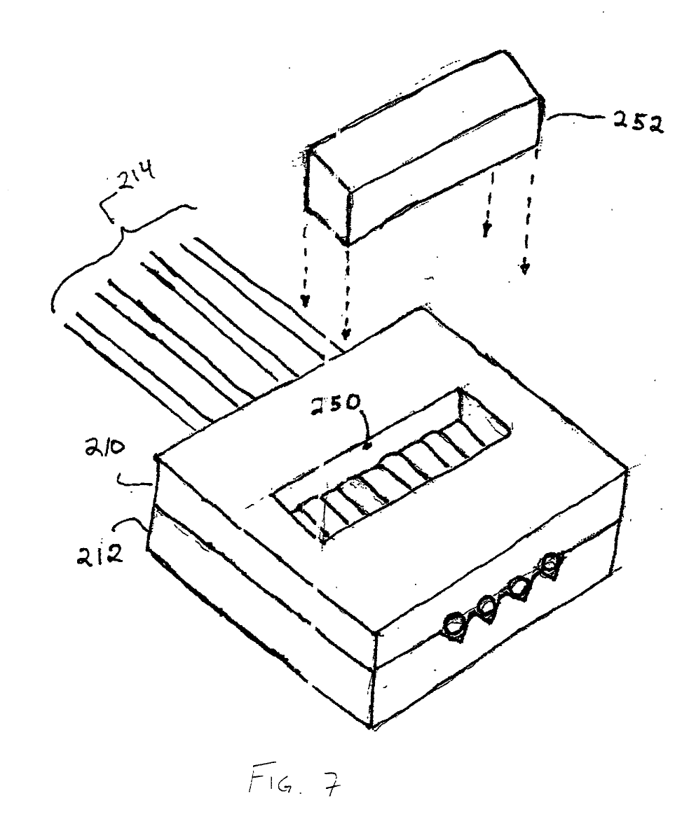

In another embodiment, shown in FIG. 7, the via hole 230 may be sufficiently large such that a plurality of optical fibers are exposed through the multi-fiber via hole 250. The adhesive is injected through the multi-fiber via hole 250 to bond the optical fibers and the upper and lower substrates.

In a further embodiment, also illustrated in FIG. 7, the adhesive is injected into the multi-fiber via hole 250, then a mechanical plunger 252 is inserted into the multi-fiber via hole 250 in order to force the adhesive through the channel 234, the guides 216 and 218, and between the upper substrate 210 and the lower substrate 212.

Having described preferred embodiments of a multi-fiber array and a method of fabricating the array according to the present invention, modifications and variations can be readily made by those skilled in the art in light of the above teachings. It is therefore to be understood that, within the scope of the appended claims, the present invention can be practiced in a manner other than as specifically described herein.

1. A method for fabricating a fiber array, the method comprising:
providing a substrate having a plurality of guides formed therein each penetrating through the substrate, the substrate having one or more via holes in fluid communication with the plurality of guides;
disposing a plurality of optical fibers with respective guides, each of the optical fibers being placed with a corresponding one of the guides; and
injecting an adhesive into the one or more via holes, the adhesive fixing the optical fibers in the respective guides of the substrate.

2. The method of claim 1, wherein each guide is in communication with a corresponding via hole.

3. The method of claim 1, wherein each via hole is offset from the plurality of guides.

4. The method of claim 1, wherein the one or more via holes are disposed on one side of the substrate.

5. The method of claim 1, wherein the one or more via holes are disposed on two sides of the substrate.

6. The method of claim 1, wherein each guide of the plurality of guides is a through-hole.

7. The method of claim 1, wherein the substrate comprises a lower substrate having the plurality of guides and an upper substrate.

8. The method of claim 7, wherein the upper substrate includes a guide corresponding to a guide of the plurality of guides on the lower substrate.

9. The method of claim 1, wherein the method further comprises:
adjusting positions of each optical fiber to be aligned in accordance with a predetermined optical alignment before injecting the adhesive.

10. The method of claim 9, wherein the predetermined optical alignment is determined by the configuration of the guides formed in the substrate.

11. The method of claim 10, wherein the guides formed in the substrate are configured in a V-groove shape on a lower portion thereof.

12. The method of claim 11, wherein the guides formed in the substrate are configured in a V-groove shape on a lower and upper portion thereof.

13. The method of claim 12, wherein the substrate includes a lower and an upper substrate, wherein at least one of the lower and upper substrates includes the guides configured to align the optical fibers in the predetermined optical alignment.

14. The method of claim 1, wherein the one or more via holes is in fluid communication with a channel having fluid communication with the plurality of guides.

15. The method of claim 1, wherein the adhesive is an epoxy.

16. The method of claim 1, wherein the adhesive is a thermally cured adhesive.

17. The method of claim 1, wherein the adhesive is a glass material having a melting temperature less than that of the optical fibers comprising glass.

18. The method of claim 1, wherein the adhesive is a solder.

19. The method of claim 18, wherein the optical fibers, the plurality of guides, and the one or more via holes are coated with a metal coating.

20. The method of claim 1, wherein the one or more via holes are disposed in at least one of a front face and a rear face of the substrate.

21. An array of a plurality of optical fibers, comprising:
a substrate having a plurality of guides formed therein, the substrate having one or more via holes in fluid communication with the plurality of guides;
the plurality of optical fibers each disposed within respective guides, each of the optical fibers being placed within a corresponding one of the guides in the substrate; and
adhesive material surrounding each of the optical fibers in a corresponding guide to fix the position of each optical fiber, the adhesive being applied through the one or more via holes.

22. The array of claim 21, wherein each guide is in communication with a corresponding via hole.

23. The array of claim 21, wherein each via hole is offset from the plurality of guides.

24. The array of claim 21, wherein the one or more via holes are disposed on one side of the substrate.

25. The array of claim 21, wherein the one or more via holes are disposed on two sides of the substrate.

26. The array of claim 21, wherein each guide of the plurality of guides is a through-hole.

27. The array of claim 21, wherein the substrate comprises a lower substrate having the plurality of guides and an upper substrate.

28. The array of claim 27, wherein the upper substrate includes a guide corresponding to a guide of the plurality of guides on the lower substrate.

29. The array of claim 21, wherein the one or more via holes is in fluid communication with a channel having fluid communication with the plurality of guides.

30. The method of claim 21, wherein the adhesive is an epoxy.

31. The method of claim 21, wherein the adhesive is a thermally cured adhesive.

32. The method of claim 21, wherein the adhesive is a glass material having a melting temperature less than that of the optical fibers comprising glass.

33. The method of claim 21, wherein the adhesive is a solder.

34. The method of claim 33, wherein the optical fibers, the plurality of guides, and the one or more via holes are coated with a metal coating.

35. The method of claim 21, wherein the one or more via holes are disposed in at least one of a front face and a rear face of the substrate.

36. A method for fabricating a fiber array, the method comprising:
providing a first substrate having a plurality of guides formed therein each guide of the plurality of guides penetrating through the first substrate, disposing a plurality of optical fibers with respective guides, each optical fiber being placed in correspondence with a respective guide;
disposing a second substrate on the plurality of fibers, the second substrate having one or more via holes in fluid communication with the plurality of guides;
injecting an adhesive into the one or more via holes; and
inserting a mechanical plunger into one or more via holes to force the adhesive through the via holes and through out the fiber array.

37. The method of claim 36 wherein the adhesive is an epoxy.

38. The method of claim 36 wherein the adhesive is a thermally cured adhesive.

39. The method of claim 36, wherein the adhesive is a glass material having a melting temperature less than that of the optical fibers comprising glass.

40. The method of claim 36, wherein the adhesive is a solder.

41. The method of claim 40, wherein the optical fibers, the plurality of guides, and the one or more via holes are coated with a metal coating.

42. The method of claim 36, wherein the one or more via holes are disposed in at least one of a front face and a rear face of the substrate.
